(19) United States
(12) Patent Application Publication
(10) Pub. No.: US 2019/0139064 A1
(43) Pub. Date: May 9, 2019

(54) INFERENCE SYSTEM FOR DATA RELATION, METHOD AND SYSTEM FOR GENERATING MARKETING TARGET GROUPS

(71) Applicant: INSTITUTE FOR INFORMATION INDUSTRY, Taipei (TW)

(72) Inventors: Ping-I Chen, Taipei City (TW); Tai-Ta Kuo, Taoyuan City (TW); Yen-Heng Tsao, New Taipei City (TW); Fu-Jheng Jheng, Taoyuan City (TW); Yu-Chuan Yang, Taichung City (TW)

(21) Appl. No.: 15/831,406

(22) Filed: Dec. 5, 2017

(30) Foreign Application Priority Data
Nov. 9, 2017 (TW) 106138834

(51) Int. Cl. G06Q 30/02; G06F 17/30

(52) U.S. Cl. CPC G06Q 30/0204; G06F 17/3053; G06Q 30/0201

(57) ABSTRACT

An inference system for data relation, method and system for generating marketing target groups are disclosed herein. The method includes the following operations: inputting a product name; determining a first group type of the product name from a specified data source according to the product name and finding a first interesting field and at least one first interesting data in the first interesting field corresponding to the first group type; establishing a customer persona model, wherein the customer persona model contains second group types, each of second group types has a second interesting field and at least one second interesting data in the second interesting field corresponding to the second group type; comparing the at least one second interesting data of the second group type of the customer persona model with the at least one first interesting data, and screening at least one marketing target group.

### RELATED APPLICATIONS

This application claims priority to Taiwan Application Serial Number 106138834, filed Nov. 9, 2017, the entirety of which is herein incorporated by reference.

### BACKGROUND

### Field of Invention

The present invention relates to an inference system for data relation, and a method and a system for generating marketing target groups. Particularly, the present invention relates to a method for inferring data relation, and a method and a system for applying a customer persona model to the marketing target groups.

### Description of Related Art

As modernized commercial marketing patterns are maturing day by day, commodity sales volumes generally relate to advertising to a high extent. Therefore, before selling, merchants would launch a merchandise advertisement to a sales target group of a commodity as the merchandise promotion. As a result, it would be an important issue that how the sales target group of the commodity would be selected and how the advertisement would be launched in activity regions of the sales target group or onto web pages browsed by these people.

Currently, an existing practice in the industry is: preliminarily planning a sales target group of a commodity by marketing personnel, then collecting samples by way of a questionnaire survey, and establishing a feature persona of the target group. However, the questionnaire survey is limited by the collected sample amount, and is time consuming. Therefore, it becomes one of issues to be improved in this art that how target group features could be discovered quickly, or, further, how a name list of customer groups could be found directly such that the advertisement could be launched specially to its target group.

### SUMMARY

The present invention mainly provides an inference system for data relation, and a method and a system for generating marketing target groups. The present invention mainly improves previous methods of finding feature personae of target groups, and solves the problem due to too much time taken for sample collection methods and the limitation due to the sample amount, thus achieving the immediate discovery of target group features or name lists and providing a marketing planning scheme.

To achieve the aforesaid purpose, a first aspect of the present invention provides a method for generating marketing target groups. The method includes the following steps: inputting a product name by an input device; determining a first group type of the product name from a specified data source according to the product name and finding a first interesting field and at least one first interesting data in the first interesting field corresponding to the first group type by a processor; establishing a customer persona model by the processor, wherein the customer persona model includes second group types, and each of the second group types has a second interesting field and at least one second interesting data within the second interesting field; and comparing the at least one second interesting data of the second group type of the customer persona model with the at least one first interesting data by the processor, and filtering at least one marketing target group.

A second aspect of the present invention provides a system for generating marketing target groups, which includes a processor, a storage device, and an input device. The storage device is electrically connected to the processor, for storing a customer persona model, wherein the customer persona model includes second group types. Each of the second group types has a second interesting field and at least one second interesting data in the second interesting field. The input device is electrically connected to the processor, for providing an interface to input a product name. The processor includes a determining module, a storage device, and a marketing target group generation module. The determining module is configured for determining a first group type of the product name from a specified data source according to the product name and finding a first interesting field and at least one first interesting data in the first interesting field corresponding to the first group type. The storage device is configured for storing the customer persona model, wherein the customer persona model includes second group types. Each of the second group types has a second interesting field and at least one second interesting data in the second interesting field. In addition, the marketing target group generation module is electrically connected with the determining module and the storage device for respectively comparing the at least one second interesting data of the second group type of the customer persona model with the at least one first interesting data, and filtering at least one marketing target group.

A third aspect of the present invention provides an inference system for data relation, including a plurality of data sources, a processor, and a storage device. The processor includes an association calculation module and a customer persona generation module. The association calculation module is electrically connected with the data sources for converting the data sources so as to generate a normalized data set. The normalized data set includes data sequences. Each of the data sequences includes a basic field and an interesting field. The data sources determines a first portion of a basic field and a first portion of an interesting field for one of the data sequences, and performs an association calculation for the normalized data set to generate at least one inference rule. In addition, the customer persona generation module is electrically connected with the association calculation module, for inferring a second portion of the basic field and a second portion of the interesting field for one of the data sequence according to the at least one inference rule. A customer persona model is obtained by, for one of the data sequences, combining the first portion and the second portion of the basic field after inference and combining the first portion and the second portion of the interesting field after inference, and is stored in the storage device. The basic field includes basic data, and the interesting field includes at least one interesting data.

The inference system for data relation, the method and system for generating marketing target groups disclosed in the present invention mainly improve previous methods of finding feature personae of a target group, solves the problem due to too much time taken for sample collection methods and the limitation due to the sample amount, thus achieving the immediate discovery of target group features or name lists and providing a marketing planning scheme.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional block diagram illustrating a marketing target group generation system according to an embodiment of the disclosure.

FIG. 2 is a flow diagram illustrating a method for generating marketing target groups according to an embodiment of the disclosure.

FIG. 3 is a flow diagram illustrating a step S220 according to an embodiment of the disclosure.

FIG. 4 is a flow diagram illustrating a step S230 according to an embodiment of the disclosure.

FIG. 5 is a flow diagram illustrating a step S320 according to an embodiment of the disclosure.

FIG. 6A is a schematic diagram illustrating data sequences according to an embodiment of the disclosure.

FIG. 6B is a schematic diagram illustrating data sequences after the association calculation according to an embodiment of the disclosure.

FIG. 7 is a functional block diagram illustrating an inference system for data relation according to an embodiment of the disclosure.

### DETAILED DESCRIPTION

The disclosure below provides many different embodiments or examples of implementing varying features in the present invention. In the discussion below, elements and configurations in special examples are used for simplifying the disclosure. Any discussed example may be used for illustration only, and will not limit the present invention or scopes and meanings of examples thereof by any way. In addition, the disclosure may repeat identical numeric symbols and/or letters in different examples only for the purpose of simplification and explanation. The repetition itself does not designate the relation between different embodiments and/or arrangements in the discussion below.

Otherwise specially noted, each of terms used through the specification and claims generally has its regular meaning as used in this art, the content in this disclosure, and special content. Certain terms used to describe this disclosure will be discussed below, or elsewhere in this specification, to provide persons skilled in this art with additional guidance on the description about this disclosure.

“Couple” or “connect” used herein may both refer to two and more elements being in direct or indirect contact with each other physically or electrically. “Couple” or “connect” may also refer to two or more elements being operating or acting on each other.

It is understandable to use the first, second, third, or other terms herein for the purpose of describing various elements, components, regions, layers and/or blocks. However, these elements, components, regions, layers and/or blocks should not be limited by the terms aforesaid. These terms may be used to distinguish a single element, component, region, layer and/or block only. Therefore, a first element, component, region, layer and/or block below may also be referred to as a second element, component, region, layer and/or block without departing from the present invention's intention. As used herein, the term “and/or” includes any combinations of one or more of listed relevant items. “And/or” mentioned in the present invention refers to any combinations of any, all, or at least one elements listed in the table.

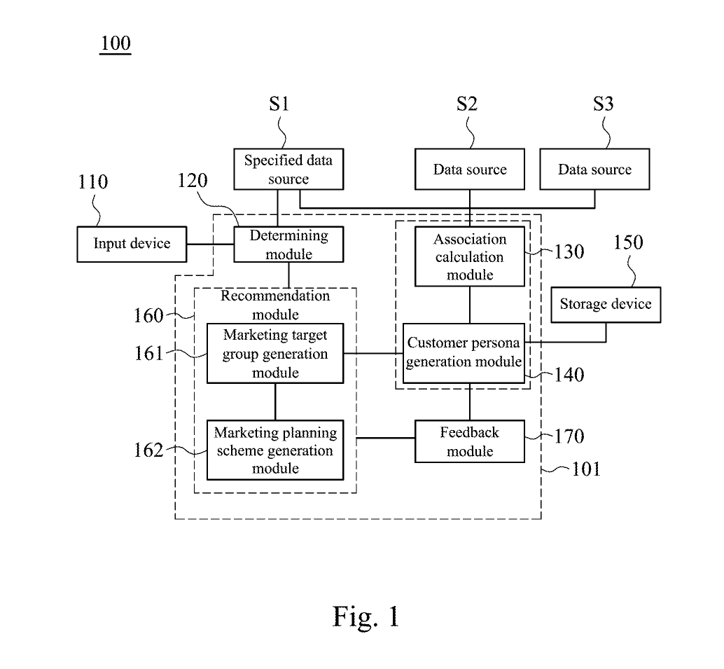

Reference is made to FIG. 1, which is a functional block diagram illustrating a marketing target group generation system 100 according to an embodiment of the disclosure. As shown in FIG. 1, the marketing target group generation system 100 includes a processor 101, a storage device 150, and an input device 110. The storage device 150 is electrically connected to the processor 101, which has a customer persona model stored therein. The customer persona model includes second group types. Each of the second group types has a corresponding second interesting field, as well as at least one second interesting data within the second interesting field. The input device 110 is electrically connected to the processor 101 for providing an interface to input the product name. The processor 101 includes a determining module 120, an association calculation module 130, a customer persona generation module 140, a storage device 150, a recommendation module 160, and a feedback module 170. The marketing target group generation system 100 may be electrically connected to an external specified data source S1, and data sources S2 and S3. The recommendation module 160 includes a marketing target-group generation module 161 and a marketing planning scheme generation module 162. The determining module 120 is electrically connected with the specified data source S1 and the recommendation module 160. The association calculation module 130 is electrically connected with the specified data source S1 and the data sources S2 and S3. The customer persona generation module 140 is electrically connected with the association calculation module 130, the storage device 150, and the marketing target group generation module 161. The feedback module 170 is electrically connected with the recommendation module 160 and the customer persona generation module 140. The determining module 120 is configured for determining from the specified data source S1 a first group type of the corresponding product name, and finding out a first interesting field corresponding to the first group type, along with at least one first interesting data within the first interesting field. The storage device 150 is configured for storing the customer persona model, wherein the customer persona model includes second group types. Each of the second group types has its corresponding second interesting field and at least one second interesting data within the second interesting field. The marketing target group generation module 161 is used for respectively comparing the at least one first interesting data with the at least one second interesting data within each second group type in the customer persona model, filtering at least one marketing target group.

Please refer to FIG. 1 continually. The association calculation module 130 is configured to convert the specified data source S1 and the data sources S2, S3 to generate a normalized data set. The normalized data set includes data sequences. Each of the data sequences includes a third basic field and a third interesting field. The specified data source S1 and the data sources S2, S3 are configured to determine a first portion of the basic field and a first portion of the third interesting field for one of the data sequences, and perform the association calculation for the normalized data set so as to generate at least one inference rule. The customer persona generation module 140 is configured to utilize at least one inference rule to infer a second portion of the third basic field and a second portion of the third interesting field for the data sequence. A customer persona model is obtained by combining the first portion and the inferred second portion of the third basic field and combining the first portion and the inferred second portion of the third interesting field for this data sequence. The marketing planning scheme generation module 162 is configured for generating a marketing planning scheme according to basic data and interesting data of at least one marketing target group. The marketing planning scheme includes marketing activity locations, marketing activity times, and group preferences, etc. The feedback module 170 is configured for re-performing the association calculation according to the marketing result data, so as to generate a modified inference rule.

In some embodiments, the input device 110 may be a keyboard, touchscreen, microphone, or other suitable input device. The marketing target-group generation system 100 may be connected with the input device 110 through an I/O interface, thus allowing the input device's data being input to and output from the marketing target-group generation system 100. For example, a touchscreen may display a user interface so as to provide the user input data to the marketing target-group generation system 100.

In some embodiments, the storage device 150 may include a portable computer-readable recording medium, such as a memory, a hard disk, a USB drive, a memory card, etc. In certain embodiments, a computer program and data may be stored on the portable computer-readable recording medium, and loaded onto the storage device via an I/O interface. Also, the I/O interface may be connected to a display. The determining module 120, the association calculation module 130, the customer persona generation module 140, the recommendation module 160, and the feedback module 170 may all be implemented as an integrated circuit, such as a microcontroller, a microprocessor, a digital signal processor, an application specific integrated circuit (ASIC), a logic circuit, or other similar elements, or combinations of the elements aforesaid.

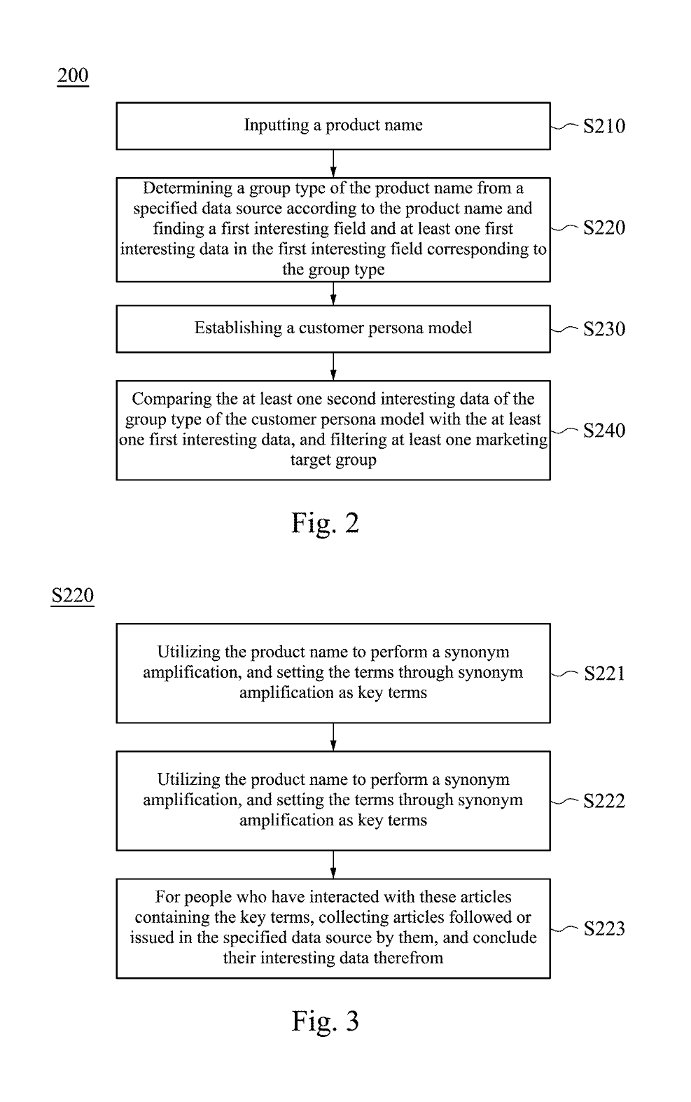

Reference is made to FIG. 2, which is a flow diagram illustrating a method for generating marketing target groups according to an embodiment of the disclosure. In the method 200 for generating marketing target groups of the first embodiment in the present invention, data collected from data sources is put through the association calculation, and a customer persona is generated accordingly. Then, according to the generated customer persona, a marketing target group is inferred, and a marketing planning scheme is generated accordingly. As shown in FIG. 2, the method 200 for generating marketing target groups includes the following steps:

Step S210: inputting a product name;

Step S220: determining a group type of the product name from a specified data source according to the product name and finding a first interesting field and at least one first interesting data in the first interesting field corresponding to the group type;

Step S230: establishing a customer persona model; and

Step S240: comparing the at least one second interesting data of the group type of the customer persona model with the at least one first interesting data, and filtering at least one marketing target group.

To be convenient for explanation, reference is made to FIG. 1-FIG. 6B. In the Step S210, an interface is provided for a user to enter a product name by this interface. For example, the user may enter “I'd like to sell a lipstick used by females”.

In the Step S220, according to the product name, the group type is determined from the specified data source, which corresponds to the product name, and the first interesting field corresponding to the group type and the at least one first interesting data within the first interesting field are found out. In this embodiment, the specified data source S1 may be data from Facebook, and also may be data from other social media or from other particular database. Data containing the interesting data only, not necessarily data from Facebook, would be enough for subsequent operations. Reference is made to FIG. 3 FIG. 3 is a flow diagram illustrating a step S220 according to an embodiment of the disclosure. As shown in FIG. 3, the Step S220 includes the following steps:

Step S221: utilizing the product name to perform a synonym amplification, and setting the terms through synonym amplification as key terms;

Step S222: searching for articles containing the key terms in the specified data source, and finding out people who have interacted with these articles; and

Step S223: For people who have interacted with these articles containing the key terms, collecting articles followed or issued in the specified data source by them, and conclude their interesting data therefrom.

In the Step S221, taking the aforesaid “I'd like to sell a lipstick used by females” input by a user as an example, after “lipstick used by females” is amplified, key terms may include “lipstick”, “beauty and cosmetics”, “cosmetics”, “Dior (a cosmetic brand)”, etc.

In the Step S222, the key terms “lipstick”, “beauty and cosmetics”, “cosmetics”, “Dior (a cosmetic brand)”, etc. are utilized to search for articles on Facebook, as well as persons who have interacted with the articles. For example, people who shared, commented, and gave a thumb for these articles.

In the Step S223, after the people who have interacted with articles containing “lipstick”, “beauty and cosmetics”, “cosmetics”, “Dior (a cosmetic brand) and other terms are found out, it may be further found that what articles they have issued or followed, or what fan groups they have followed, thus concluding the first interesting data of a group of people interested in “lipstick”, “beauty and cosmetics”, “cosmetics”, “Dior (a cosmetic brand) and other terms. The first interesting data may be sharing of stuff interesting this group, comments, or commodity categories and fan pages, etc.

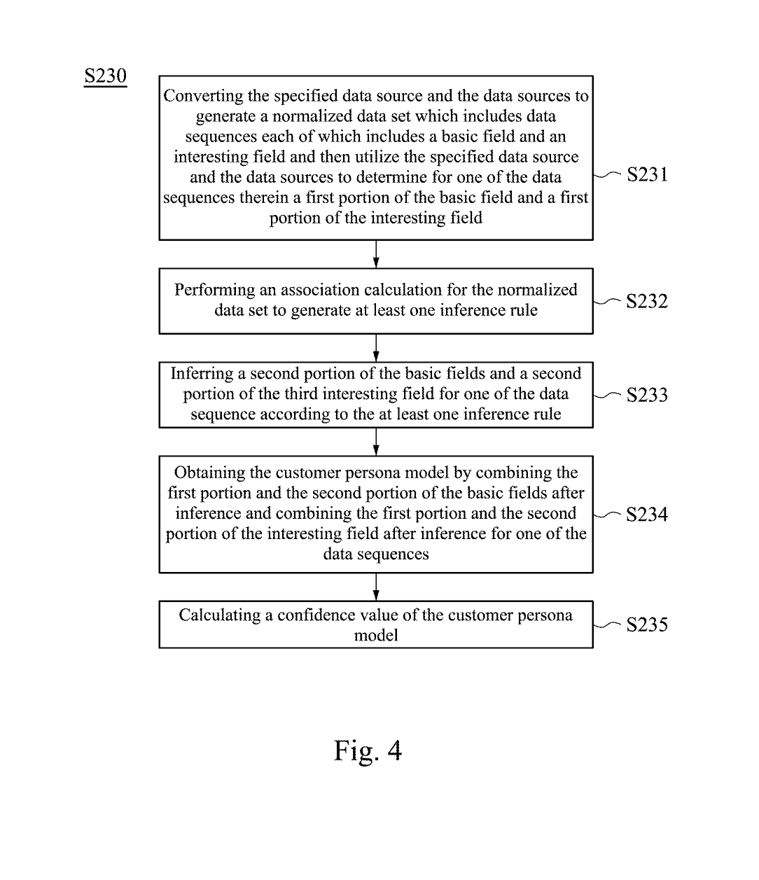

Through the process in the steps S221-S223, all Facebook data become de-individual-informationized and normalized feature materials. In the Step S230, a customer persona model is established. Different data sources S2 and S3 are utilized for performing the association calculation to result in a customer persona model by coinciding. In embodiments of the present invention, the specified data source S1 is data from Facebook. The data sources S2 and S3 may be data from telecom operators or from physical sale channels. The data sources S2 and S3 may be de-individual-informationized data, without needing further process in the Steps S221-S223. If any data source needs further processes, the way in Steps S221-S223 may also be employed. Next, please refer to FIG. 4. FIG. 4 is a flowchart of the Step S230, which is depicted in accordance with some embodiments in the present invention. As shown in FIG. 4, Step S230 includes the following steps:

Step S231: Converting the specified data source and the data sources to generate a normalized data set which includes data sequences each of which includes a basic field and an interesting field and then utilize the specified data source and the data sources to determine for one of the data sequences therein a first portion of the basic field and a first portion of the interesting field;

Step S232: performing an association calculation for the normalized data set to generate at least one inference rule;

Step S233: inferring a second portion of the basic fields and a second portion of the third interesting field for one of the data sequence according to the at least one inference rule;

Step S234: obtaining the customer persona model by combining the first portion and the second portion of the basic fields after inference and combining the first portion and the second portion of the interesting field after inference for one of the data sequences; and

Step S235: calculating a confidence value of the customer persona model.

In the Step S231, the specified data source S1 and the data sources S2 and S3 are required to be firstly converted into a same dimension in terms of interest categories. The interest categories are set as 75 categories in the present invention. They may be also set as other categories which cause no impact on the present invention. For example, if there is a term “lipstick” in the interesting data in the specified data source S1, the “lipstick” is required to be converted to “cosmetics”. If there is a term “lip cream” in the data source S2, the “lip cream” is required to be converted to “cosmetics” as well. Next, the normalized specified data source S1 and the data sources S2 and S3 form a normalized data set. The normalized data set includes many data sequences. Each of the data sequence has a basic field and an interesting field. However, due to the source difference of data sources, among other issues, the data sequences may be inadequate in basic data of the basic fields or interesting data of the interesting fields. Content recorded in the interesting field in each data sequence of the normalized data set may represent at least one second interesting data of each group type in the customer persona model.

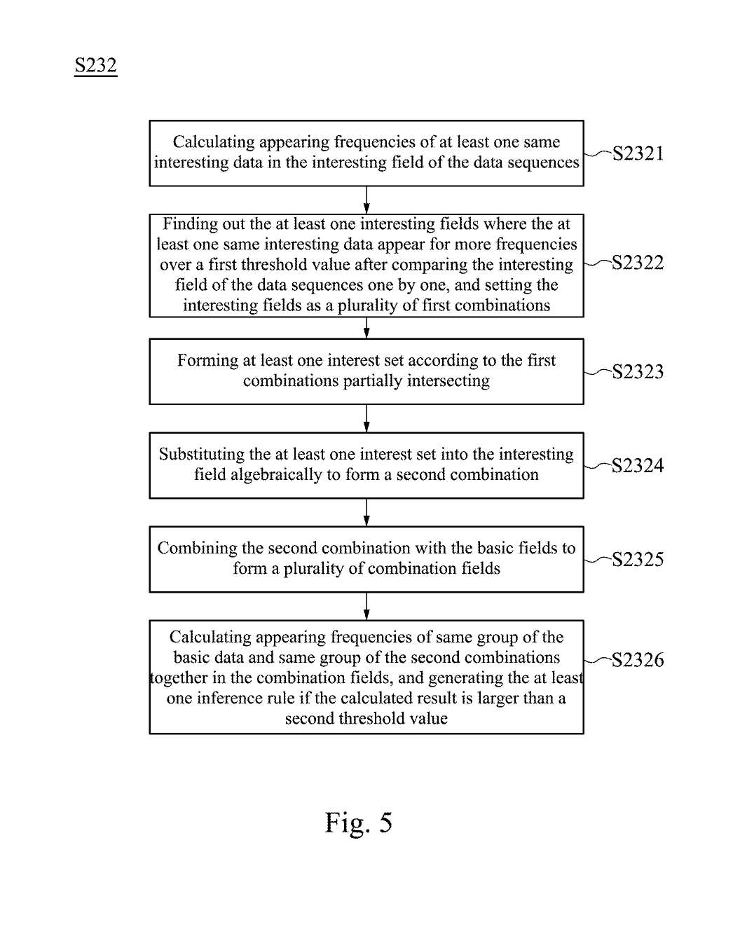

In the Step S232, a association calculation is performed for the normalized data set to generate an inference rule. Reference is made to FIG. 5 next for the way of association calculation. FIG. 5 is a flow diagram illustrating a step S320 according to an embodiment of the disclosure. As shown in FIG. 5, Step S232 includes the following steps:

Step S2321: calculating appearing frequencies of at least one same interesting data in the interesting field of the data sequences;

Step S2322: finding out the at least one interesting fields where the at least one same interesting data appear for more frequencies over a first threshold value after comparing the interesting field of the data sequences one by one, and setting the interesting fields as a plurality of first combinations;

Step S2323: forming at least one interest set according to the first combinations partially intersecting;

Step S2324: substituting the at least one interest set into the interesting field algebraically to form a second combination;

Step S2325: combining the second combination with the basic fields to form a plurality of combination fields; and

Step S2326: calculating appearing frequencies of same group of the basic data and same group of the second combinations together in the combination fields, and generating the at least one inference rule if the calculated result is larger than a second threshold value.

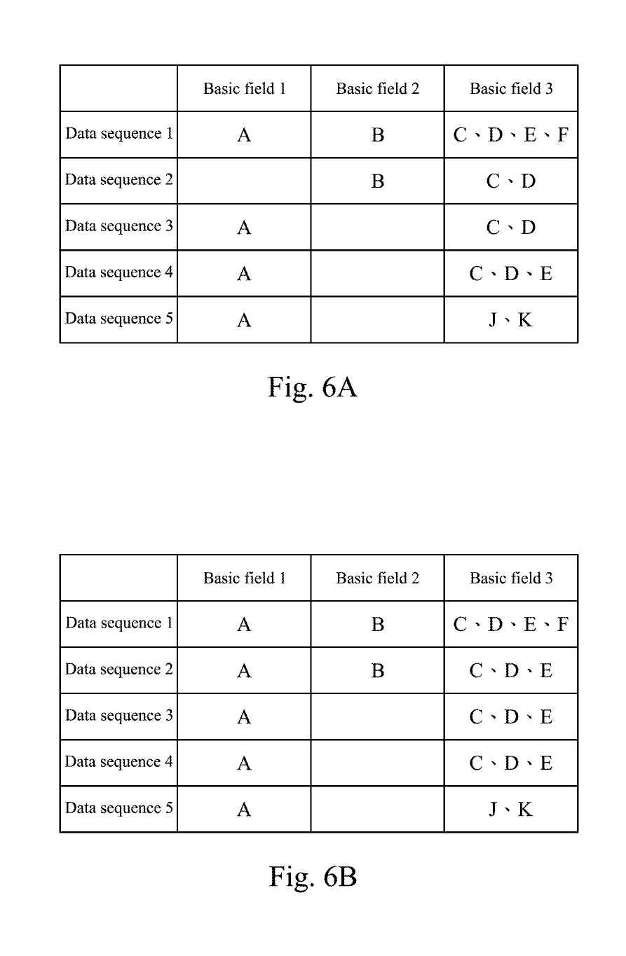

Reference is made to FIG. 6A, which is a schematic diagram illustrating data sequences according to an embodiment of the disclosure. As shown in FIG. 6A, there are 5 data sequences in total. Data A and Data B represent basic data in basic field 1 and basic field 2 respectively. Data C, Data D, Data E, Data F, Data J, and Data K represent interesting data in the interesting field. In the Step S2321, the occurrence times of the at least one same interesting data in the interesting field would be calculated. In this example, Data C and Data D both occur for 4 times, Data E for 2 times, Data F, Data J, and Data K all occur for 1 time.

In the Step S2322, those interesting fields are found out where the at least one same interesting data occur more frequently than a first threshold value does. Then, these fields are set as first combinations. If the first threshold value is set as n/2, because there are 5 pieces of data (n=5) in total in this example, the interesting data may be taken into consideration only when it occurs more than 2 times. Therefore, Data J and K in data sequence 5 would be filtered out for they occur for only once. While in the interesting fields of data sequences 1-4, all data occur for more times over the first threshold value, the first combinations become CDEF, CDE, and CD.

In the Step S2323, the intersection portions of the first combinations form at least one interest set. In this example, after intersection, the first combinations CDEF, CDE, and CD form a first interest set CD and a second interest set CDE.

In the Step S2324, the at least one interest set is substituted into the interesting fields algebraically to generate a second combination. In this example, the first interest set CD may be considered as I1, the second interest set CDE may be considered as I2. Therefore, when substituted into the interesting field again, the interesting data of data sequence 1 may be in three potential ways: I1, I2, and I2F. The interesting data of data sequence 2 is I1, the interesting data of data sequence 3 is I1, and data sequence 4 may have I1 and I2 potential kinds of interesting data.

In the Step S2325, the second combination is combined with the basic field to form combination fields. Data sequence 1 has combination fields of three kinds in total: ABI1, ABI2, and ABI2F. Data sequence 2 has 1 kind of combination field: BI1. Data sequence 3 has 1 kind of combination field: AI1. Data sequence 4 has 2 kinds of combination field: AI1 and AI2.

In the Step S2326, the occurrence times of the same basic data and the same second combinations together in the combination field are calculated. At least one inference rule is generated if the calculation result is larger than a second threshold value. If the second threshold value is set as m/2, because there are 6 kinds of interesting data (m=6) in total in this example, the combination may be taken into consideration only when it occurs more than 3 times. AI1 and AI2 occur together for 3 times in total, BI1 and BI2 occur together for 3 times in total, and AI2F, B12F, ABI1, ABI2, ABI2F occur together for only once. Therefore, the inference rule is finding out ACD and ACDE represented by AI1 and AI2.

In the Step S233, for one of the data sequences, a second portion of the basic field and a second portion of the interesting field are inferred according to the inference rule. Any inadequate basic data or interesting data in the data sequence are supplemented to form a customer persona model. Please refer to FIG. 6B. FIG. 6B is a schematic view of data sequences after the association calculation, which is depicted in accordance with some embodiments in the present invention. As shown in FIG. 6B, in this example, according to inference rules ACD and ACDE found aforesaid, it may be inferred that basic field 1 of data sequence 2 has Data A, the interesting field may be supplemented with Data E, and the interesting field of data sequence 3 may also be supplemented with Data E.

In the Step S234, a customer persona model is obtained by combining the first portion and the inferred second portion of the basic field and combining the first portion and the inferred second portion of the interesting field for the data sequence. In this example, original basic Data B of data sequence 2 along with interesting Data C and D are combined the inferred basic Data A and interesting Data E, finally obtaining the customer persona model of basic Data A and B, interesting Data C, D and E. Original basic Data A of data sequence 3 along with interesting Data C and D are combined with inferred interesting Data E, eventually obtaining the customer persona model of basic Data A, interesting Data C, D, and E.

In the Step S235, a confidence value is calculated for the customer persona model. The confidence value may be calculated according to the amount of inferred data. For example, confidence value=(1−inferred data amount/original data amount)*100%. Continued with the aforesaid embodiment, data sequence 2 had 3 pieces of data, and is now supplemented with 2 pieces of data more through the association calculation. Therefore, the confidence value of data sequence 2=(1−⅔)* 100%≈33%. Data sequence 3 had 3 pieces of data, and is now supplemented with 1 piece of data more through the association calculation. Therefore, the confidence value of data sequence 3=(1−⅓)* 100%≈67%. The above calculation forms of confidence value are illustrative only. Other calculation forms may be adopted as well and not limited so.

In step S240: The at least one first interesting data is compared respectively with at least one second interesting data of each group type of the customer persona model, and filtering at least one marketing target group. After the customer persona model is calculated, the group type corresponding to the product name input in Step S210 may be utilized to screen a marketing target group.

For example, “I'd like to sell a lipstick used by females” may be used to find out a group of people interested in lipsticks for females from a particular database (such as Facebook) for further collecting first interesting data of this group. For example, these people are also interested in “fashion magazine”, “accessory”, etc. If finding corresponding second in the interesting field of the established customer persona model according to the first interesting data, those interesting fields consistent with “fashion magazine” and “accessory” may be discovered in the customer persona model. One or more data sequences may be found, with each data sequence having a corresponding basic field. For example, the basic field corresponding to “fashion magazine” is “aging 18 to 36”, “medium consumption capacity”, and “activity located at Xinyi, Taipei”. For example again, “I'd sell false tooth adhesives” may be used to find out people interested in false tooth adhesives from particular database (such as Facebook) and further collect their first interesting data. For example, this group of people may be also interested in “health caring”, “nutritious foods”, and “natural diet”, etc. If finding second interesting data from the interesting field of the established customer persona model according to the first interesting data, those interesting fields consistent with “health caring”, “nutritious foods”, and “natural diet” may be discovered in the customer persona model. One or more data sequences may be found, with each data sequence having a corresponding basic field. For example, the basic field corresponding to “natural diet” is “aging 45-70”, “high consumption capacity”, and “purchase pattern is shopping in physical shopping malls”. Certainly, the confidence value may also be used to adjust the promotion order. Marketing target groups with high confidence values will be promoted to users preferentially.

In this embodiment, the basic data and interesting data of the marketing target group may be used to generate a marketing planning scheme. The marketing planning scheme may include advertisement setup locations, play timing, basic group properties, and group preferences, etc. For example, for the marketing target group of “I'd like to sell a lipstick used by females”, activity time and range of this group may be inferred, targeted advertising is carried out, or the advertisement may also be launched on webpages where this group often view on the net.

In this embodiment, marketing result data is collected after practical advertisement launch. The association calculation may be re-performed according to the marketing result data to generate a modified inference rule. In addition, the first threshold value and the second threshold value may be adjusted to alter the amount of inference rules, which also influences the amount of customer persona models and the accuracy of inference.

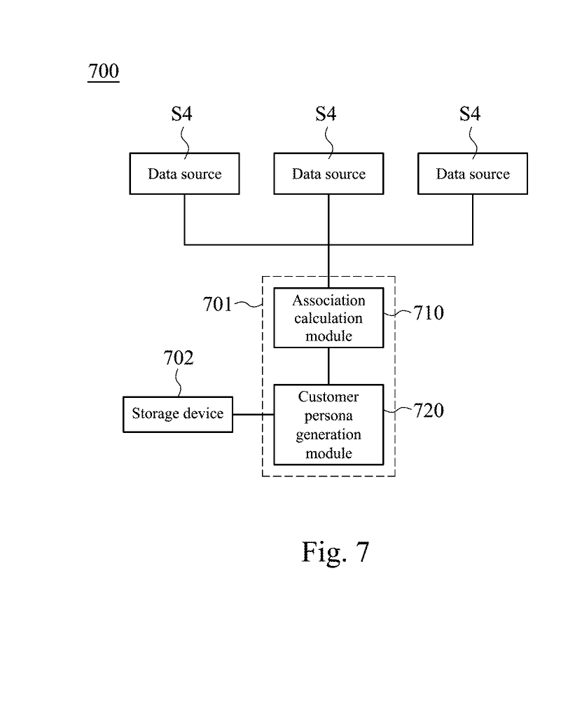

Reference is made to FIG. 7, which is a functional block diagram illustrating an inference system for data relation according to an embodiment of the disclosure. As shown in FIG. 7, the inference system for data relation 700 includes a data source S4, a processor 701, and a storage device 702, wherein the processor 701 includes an association calculation module 710 and a customer persona generation module 720. The association calculation module 710 is connected with a data source S4 for converting the data source S4 to generate a normalized data set. The normalized data set includes data sequences. Each data sequence includes a basic field and an interesting field. The data source S4 is used for determining a first portion of the basic field and a first portion of the interesting field for one of the data sequences. Then, for this normalized data set, an association calculation is performed to generate at least one inference rule. The customer persona generation module 720 is connected with the association calculation module 710 for using the at least one inference rule to infer for this data sequence a second portion of the basic field and a second portion of the interesting field. A customer persona model is obtained by combining the first portion and the inferred second portion of the basic field and combining the first portion and the inferred second portion of the interesting field. The customer persona model is stored in the storage device 702. The basic field includes basic data, and the interesting field includes interesting data.

It may be known from the implementations of the aforesaid present invention that it mainly improves previous methods of finding out feature personae of target groups. It uses the association calculation to find out inference rules, and combines the inference rules to calculate a customer persona models. A marketing group may be found out by using the customer persona model, and a marketing planning scheme may be developed further. The present invention solves the problem due to too much time consumption for sample collection methods and the limitation due to the sampling amount, thus achieving the immediate discovery of target group features or name lists and providing a marketing planning scheme.

In addition, although the aforesaid examples include exemplary steps in a sequence, these steps are not necessarily implemented by the shown sequence. Implementing these steps in different orders may be considered within the disclosure content. Within the spirit and scope of embodiments in the disclosure, these steps may be added, replaced, altered in sequence and/or omitted as appropriate.

Although the present invention has been disclosed as aforesaid implementations, the present invention is not limited thereby. Any of those skilled in this art may take various alternations and modifications without departing from the spirit and scope of the present invention. Therefore, the protection ranges of the present invention should be considered subject to those defined by the attached claims.

What is claimed is:

1. A method for generating marketing target groups, comprising:
inputting a product name by an input device;
determining a first group type of the product name from a specified data source according to the product name and finding a first interesting field and at least one first interesting data in the first interesting field corresponding to the first group type by a processor;
establishing a customer persona model by the processor, wherein the customer persona model includes a plurality of second group types, each of which has a second interesting field and at least one second interesting data in the second interesting field; and
comparing the at least one second interesting data of the second group type of the customer persona model with the at least one first interesting data by the processor, and filtering at least one marketing target group.

2. The method for generating marketing target groups of claim 1, wherein establishing the customer persona model further comprises:
converting the specified data source and a plurality of data sources to generate a normalized data set, the normalized data set including a plurality of data sequences each of which includes a plurality of basic fields and a third interesting field, determining, based on the specified data source and the data sources, a first portion of the basic fields and a first portion of the third interesting field for one of the data sequences;
performing an association calculation for the normalized data set to generate at least one inference rule;
inferring a second portion of the basic fields and a second portion of the third interesting field for one of the data sequence according to the at least one inference rule;
obtaining the customer persona model by combining the first portion and the inferred second portion of the basic fields and combining the first portion and the inferred second portion of the third interesting field for one of the data sequences; and
calculating a confidence value of the customer persona model;
wherein the basic fields include a plurality of basic data, and the third interesting field includes at least one interesting data.

3. The method for generating marketing target groups of claim 2, wherein the association calculation further comprises:
calculating appearing frequencies of at least one same interesting data in the interesting field of the data sequences;
finding out the at least one interesting fields where the at least one same interesting data appear for more frequencies over a first threshold value after comparing the interesting field of the data sequences one by one, and setting the interesting fields as a plurality of first combinations;
forming at least one interest set according to the first combinations partially intersecting;
substituting the at least one interest set into the third interesting field algebraically to form a second combination;
combining the second combination with the basic fields to form a plurality of combination fields; and
calculating appearing frequencies of same group of the basic data and same group of the second combinations together in the combination fields, and generating the at least one inference rule if the calculated result is larger than a second threshold value;
wherein the at least one interesting data includes the at least one first interesting data and at least one second interesting data.

4. The method for generating marketing target groups of claim 3, wherein the customer persona model is formed according to the at least one inference rule by supplementing the basic data and one of the at least one interesting data in the data sequences.

5. The method for generating marketing target groups of claim 1, wherein a confidence value is further generated corresponding to the customer persona model at the same time when the customer persona model is established, and a promotion order of the at least one marketing target group is adjusted according to the confidence value corresponding to the customer persona model.

6. The method for generating marketing target groups of claim 1, further comprising:
utilizing the basic data and the at least one interesting data of the at least one marketing target groups to generate a marketing planning scheme;
wherein the marketing planning scheme includes advertisement setup locations, play timing, basic group properties, and group preferences.

7. The method for generating marketing target groups of claim 6, further comprising:
storing a marketing result data corresponding to the marketing planning scheme; and
re-performing the association calculation to generate modified inference rules according to the marketing result data.

8. The method for generating marketing target groups of claim 2, wherein the specified data source and the data sources will convert data dimensions of the data sources according to an interest category, thus forming the normalized data set.

9. A system for generating marketing target groups, comprising:
a processor;
a storage device, electrically connected to the processor for storing a customer persona model, wherein the customer persona model includes a plurality of second group types each of which has a second interesting field and at least one second interesting data in the second interesting field; and
an input device, electrically connected to the processor for providing an interface for inputting a product name;
wherein the processor includes:
a determining module, configured for determining a first group type of the product name from a specified data source according to the product name and finding a first interesting field and at least one first interesting data in the first interesting field corresponding to the first group type; and
a marketing target group generation module, configured for comparing the at least one second interesting data of the second group type of the customer persona model with the at least one first interesting data, and filtering at least one marketing target group.

10. The system for generating marketing target groups of claim 9, wherein the processor further comprises:
an association calculation module, connected with the specified data source and a plurality of data sources, configured for converting the specified data source and the data sources to generate a normalized data set which includes a plurality of data sequences each of which includes a plurality of basic fields and a third interesting field, the specified data source and the data sources being used to determine a first portion of the basic fields and a first portion of the third interesting field for one of the data sequences, and a association calculation is performed for the normalized data set to generate at least one inference rule; and
a customer persona generation module, configured for inferring a second portion of the basic fields and a second portion of the third interesting field for one of the data sequence according to the at least one inference rule, and obtaining the customer persona model by combining the first portion and the inferred second portion of the basic fields and combining the first portion and the inferred second portion of the third interesting field for one of the data sequences;
wherein the basic fields include a plurality of basic data, and the third interesting field includes at least one interesting data.

11. The system for generating marketing target groups of claim 10, wherein the at least one interesting data comprises the at least one first interesting data and at least one second interesting data, and the association calculation module is configured for:
calculating appearing frequencies of the at least one same interesting data in the third interesting field of the data sequences;
finding out the at least one interesting fields where the at least one same interesting data appear for more frequencies over a first threshold value after comparing the interesting field of the data sequences one by one, and setting the interesting fields as a plurality of first combinations;
forming at least one interest set according to the first combinations partially intersecting;
substituting the at least one interest set into the third interesting field algebraically to form a second combination;
combining the second combination with the basic fields to form a plurality of combination fields; and
calculating appearing frequencies of same group of the basic data and same group of the second combinations together in the combination fields, and generating the at least one inference rule if the calculated result is larger than a second threshold value.

12. The system for generating marketing target groups of claim 11, wherein the customer persona model is formed according to the at least one inference rule by supplementing the basic data and one of the at least one interesting data in the data sequences.

13. The system for generating marketing target groups of claim 9, wherein the customer persona generation module generates a confidence value corresponding to the customer persona model while the customer persona model is established, and the marketing target group generation module is configured to adjust a promotion order of the at least one marketing target group according to the confidence value corresponding to the customer persona model.

14. The system for generating marketing target groups of claim 9, wherein the processor further comprises: a marketing planning scheme generation module, configured for generating a marketing planning scheme according to the basic data and the at least one interesting data of the at least one marketing target group, wherein the marketing planning scheme includes advertisement setup locations, play timing, basic group properties, and group preferences.

15. The system for generating marketing target groups of claim 9, wherein the storage device is further configured for storing a marketing result data promoted against the at least one marketing target group, and the processor further comprises:
a feedback module, configured for re-performing the association calculation to generate modified inference rules according to the marketing result data.

16. The system for generating marketing target groups of claim 10, wherein the specified data source and the data sources will convert data dimensions of the data sources according to an interest category, forming the normalized data set.

17. An inference system for data relation, comprising:
a plurality of data sources;
a processor, connected with the data sources; and
a storage device, electrically connected to the processor,
wherein the processor includes:
an association calculation module, connected with the data sources, configured for converting the data sources to generate a normalized data set which including a plurality of data sequences each of which includes a plurality of basic fields and an interesting field, the data sources being used to determine a first portion of the basic fields and a first portion of the interesting field for one of the data sequences, and performing an association calculation for the normalized data set to generate at least one inference rule; and
a customer persona generation module, connected with the association calculation module, configured for inferring a second portion of the basic fields and a second portion of the interesting field for one of the data sequence according to the at least one inference rule, and obtaining a customer persona model by combining the first portion and the second portion of the basic fields after inference and combining the first portion and the second portion of the interesting field after inference for one of the data sequences, with the customer persona model stored in the storage device;
wherein the basic fields include a plurality of basic data, and the interesting field includes at least one interesting data.
